(19) United States
(12) Patent Application Publication
(10) Pub. No.: US 2011/0139582 A1
(43) Pub. Date: Jun. 16, 2011

(54) SYSTEM AND METHOD FOR TRANSPORTING VARIABLE-SIZED MEDIA

(75) Inventor: DOUGLAS K. HERRMANN, WEBSTER, NY (US)

(73) Assignee: XEROX CORPORATION, NORWALK, CT (US)

(21) Appl. No.: 12/637,749

(22) Filed: Dec. 15, 2009

(51) Int. Cl. B65G 43/08; B65G 15/20

(52) U.S. Cl. 198/572; 198/575

(57) ABSTRACT

An apparatus for transporting variable-sized media is described. The apparatus employs multiple parallel beltsets and a control module. Multiple parallel beltsets are situated between an inlet station and a delivery station. Further, each beltset is connected to a motor which drives the beltset. The apparatus also include multiple pushers attached to the belts, such that the distance between two successive pushers is greater than the size of the largest media to be transported. The control module is coupled to each motor and adjusts the distance between the pushers of adjacent beltsets, based on the size of the media to be transported.

### TECHNICAL FIELD

The presently-disclosed embodiments generally relate to material handling transportation, and more particularly, to transporting media in material handling systems.

### BACKGROUND

Typically, material handling systems transport media (envelopes, boxes, cards, sheet material including paper, corrugated cardboard, mail or the like or stacks of sheet material) from input station(s) to output station(s), often consisting of multiple stations. A conveyor system, for example, may transport any number of media items between an inlet station(s) and a delivery station(s). Stacks of media are placed on the belts of the conveyor system between two successive pushers (an elongated member, attached to a belt at a predetermined location, separating two sections of the belt and being capable of pushing media on the conveyor system).

Many processing applications work with variable-sized media, requiring variation in the distance between two pushers. If the belt has detachable pushers, as is usually the case, manual adjustment of these pushers will be required. Alternatively, operators may add additional flight bars (bars used to vary the distance between adjacent pushers) or pushers leading to loss in productivity. In the event that variable-sized media transportation proceeds without the pusher adjustment, the media may scatter, curl, or shingle during transportation.

It would be highly desirable to have a relatively simple and cost-effective system for combining high production on a material handling line with the ability to automatically vary the distance between successive pushers.

### SUMMARY

An aspect of the disclosure provides an apparatus for transporting variable-sized media. The apparatus employs multiple parallel beltsets and a control module. Multiple parallel beltsets, having one or more parallel belts each, lie between an inlet station and a delivery station. Each beltset includes a motor, connected to the beltset, for driving the beltset. The apparatus also includes multiple pushers, attached to one or more belts of the beltset, such that the distance between two successive pushers is greater than the size of the largest media that can be transported. Further, the pushers of one beltset lie between the successive pushers of the adjacent beltset. A control module, coupled to all the motors, adjusts the distance between the pushers of adjacent beltsets, based on the size of the media to be transported.

Another embodiment disclosed here is a method for transporting variable-sized media. Multiple parallel beltsets, having one or more parallel belts each, lie between an inlet station and a delivery station. Each beltset includes a motor, connected to the beltset, for driving the beltset. Multiple pushers are attached to one or more belts of the beltset, such that the distance between two successive pushers is greater than the size of the largest media to be transported. Further, the pushers of one beltset lie between the successive pushers of the adjacent beltset. The method involves determining the size of the media to be transported between the inlet and the delivery station and using a control module for adjusting the distance between two successive pushers on the system. The control module is coupled to all the motors, allowing adjustment of the distance between the pushers. Having adjusted the pushers, the beltsets move, transporting the media from the inlet station to the delivery station.

### BRIEF DESCRIPTION OF THE DRAWINGS

FIG. 1 illustrates a conventional media transport apparatus.

FIG. 2 illustrates an exemplary apparatus for transporting variable-sized media.

FIG. 3 is an alternate view of stacked media on the apparatus of FIG. 2.

FIG. 4 exhibits an exemplary embodiment of the disclosure having two belts in each beltset for transporting variable-sized media.

FIG. 5 illustrates an alternate embodiment of the variable-sized media transport system of FIG. 4.

FIG. 6 illustrates an alternate embodiment of the variable-sized media transport system of FIG. 4.

FIG. 7 is a flowchart of an exemplary method for transporting variable-sized media.

### DETAILED DESCRIPTION

The following detailed description is made with reference to the figures. Preferred embodiments are described to illustrate the claimed invention, not to limit its scope, which is defined by the claims. Those of skill in the art will recognize a variety of equivalent variations for the embodiments described.

As used throughout this disclosure, the term “media” refers to envelopes, boxes, cards, sheet material including paper, corrugated cardboard, mail or the like or stacks of sheet material or other suitable items. It should be understood that the concepts set out here could be employed both in devices handling relatively small sized media, such as paper sheets, as well as apparatus handling large sheets of material, such as corrugated cardboard material. A “pusher” is an elongated member protruding from a conveyor belt, separating two sections of the belt. The design of the pushers is such that they can push the media on the belt. Further, the pusher location can be changed if they are detachable from the conveyor belt. The term “bin size” refers to the distance between two successive pushers. The pushers may be designed either to be individual pushers on each belt or to span the width of a belt. The pushers may even extend across the entire width of a single beltset. Alternatively, the pushers can span all belts of a beltset but may not cover the entire width of the beltset. Further, in some embodiments, the pushers may not be present on all belts of a beltset. The term “media size” refers to the size of media that can be transported. The term “TE pushers” (trailing edge pushers) refers to pushers facing the trailing edge of the media during transportation, while the term “LE pushers” (leading edge pushers) refers to pushers facing the leading edge of the media being transported.

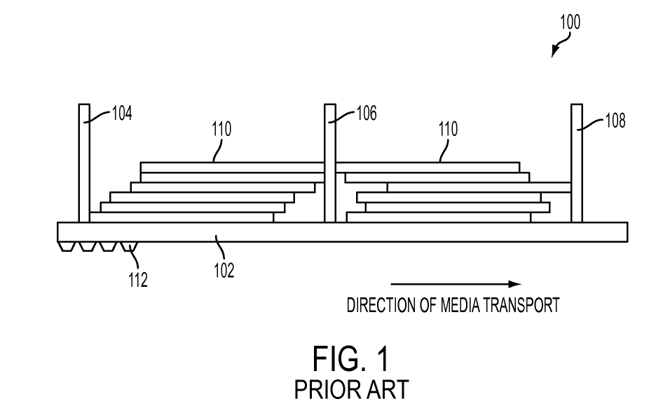

FIG. 1 illustrates a conventional media transport apparatus 100. The apparatus 100 includes a beltset 102, having one belt. Pushers 104, 106, and 108 project vertically from the beltset 102. Media 110, for transportation, are placed in the space between the pushers 104 and 106, and 106 and 108 on the beltset 102, which moves from left to right in the FIG. 1. Belt teeth 112 extend continuously (FIG. 1 shows only four teeth, for simplicity) on the inner surface of the belt from one edge to the other. The pushers 104, 106, and 108 cannot be adjusted automatically according to media size. As a result, the media 110 scatters and gets displaced, which may lead to curling, shingling, and un-stacking of the media 110 during transportation. Alternatively, to transport variable-sized media, an operator can manually move the pushers or insert separate flight bars or pushers to change the bin size if the pushers have been designed to be detachable from the belt.

According to aspects of the disclosure illustrated here, a system for transporting variable-sized media is described. The system employs multiple parallel beltsets, having one or more parallel belts each, extending between an inlet station and a delivery station. A control module directs the system, controlling motors connected to each beltset to drive the beltsets. Multiple pushers are attached to one or more belts in the beltset, such that the distance between the two successive pushers on the beltset is greater than the size of the largest media to be transported. Further, the pushers of one beltset lie between successive pushers of the adjacent beltset. The control module adjusts the distance between the pushers of the adjacent beltsets, based on the size of the media to be transported, without any operator intervention.

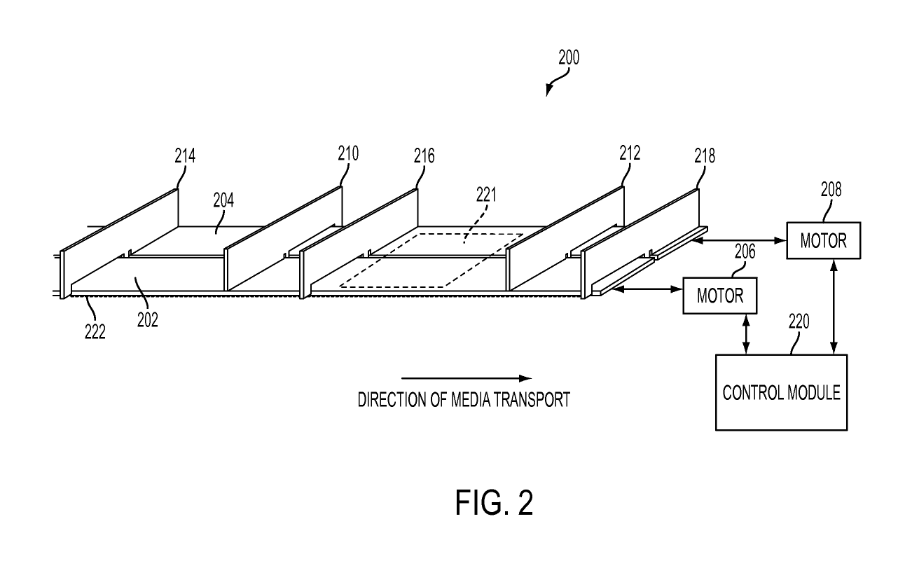

FIG. 2 illustrates an exemplary apparatus 200 for transporting variable-sized media. The apparatus 200 allows operators to maintain efficiently running machines with a minimum number of attending operators, ensuring maximum productivity.

In the present embodiment, the apparatus 200 transports media between an inlet station (not shown) and a delivery station (not shown), and can be implemented in any suitable material handling application, which involves handling variable-sized media. The inlet and the delivery stations may be printers, storage or collection areas, or processing units or the inlet and delivery stations can be part of a material handling system. Additionally, there can be multiple inlet and delivery stations within the apparatus 200.

The apparatus 200 includes a first beltset 202 and a second beltset 204 that is parallel to the first beltset 202, both having one belt each. A first motor 206 drives the first beltset 202, while a second motor 208 drives the second beltset 204. As depicted here, the apparatus 200 transports media from left to right. Pushers 210 and 212, attached to the first beltset 202, are LE pushers and pushers 214, 216, and 218, attached to the second beltset 204, are TE pushers. Although, the LE pushers 210 and 212 are attached only to the first beltset 202, these pushers span both the first beltset 202 and the second beltset 204, without making contact with the second beltset 204. Part of a pusher may protrude from the lower part of the pusher, as shown in FIG. 2, preventing the media from becoming trapped in the space between the LE pushers 210 and 212 and the second beltset 204. Such protrusions may exist at various points along the length of a pusher and may further lie between two adjacent belts or toward the outer edges of the two outer belts of the apparatus 200, as illustrated in FIG. 2. A control module 220 is coupled to the first motor 206 and the second motor 208, such that they operate independently of each other. Two successive pushers, each lying on a separate beltset, form a bin. As shown in FIG. 2, the LE pusher 212 and the TE pusher 216 form a bin 221 for carrying the media (not shown in FIG. 2 for simplicity). Based on the media size, the control module 220 may actuate either the first motor 206, or the second motor 208 to adjust the bin size. Alternatively, the control module 220 may actuate both the motors to adjust the bin size. For example, a decrease in the bin size would allow better accommodation of smaller sized media. To this end, the control module 220 actuates the first motor 206 to move the LE pusher 212 (attached to the first beltset 202) closer to the TE pusher 216 (attached to the second beltset 204) by moving the first beltset 202 from right to left, thus adjusting the bin size. This automatic adjustment precludes the need for operator intervention, which requires a human operator to move the LE pusher 212 closer to the TE pusher 216 manually. Belt teeth 222 can extend continuously on the inner surface of the belt from one edge to the other and help in achieving synchronization during belt movement. In the same manner, the control module 220 can actuate either of the motors (the first motor 206 or the second motor 208) or both the motors (the first motor 206 and the second motor 208), to move the LE pusher 212 away from the TE pusher 216, thereby increasing the bin size.

Further, a sensor device (not illustrated) determines the media size automatically. For example, the sensor device can be a RFID (Radio-Frequency Identification) reader. Accordingly, the media would carry a machine-readable marker, such as a barcode, which includes information related to the media size. The position of the sensor can be in close proximity with the inlet station or the control module 220, such that the sensor can read the marker present on the media. Those of skill in the art will recognize that the sensor system may employ a variety of equivalent electronic detectors, readers, or scanners to serve the same purpose, such as an infrared sensor, a laser sensor or the like. Further, after determining the media size, the sensor device transmits that information to the control module 220. On receiving the media size, the control module 220 actuates one or more motors to adjust the pushers, forming a bin of the desired size. For example, if the bin size is greater than the media size, the control module 220 moves the pushers closer to each other to reduce the bin size.

In another embodiment, the media size specification takes place manually. The control module 220 can have an interface that accepts the media size through user instructions. The interface may have an input device, such as a keyboard or a touch-screen and a display device, so that the user can key-in the media size and can view information related to the ongoing operation.

The belts, as described in relation with the apparatus 200, can be urethane or co-polyester belts. Alternatively, the belts can be metallic or may further be chains with attached pushers, as commonly used in a mail handling equipment. Moreover, the belts or chains can be mounted below a baffle so that only the pushers project through the baffle. Thus, the media being transported only makes contact with the pushers and not the upper surface of the belts. Further, the structure of the belts can be rough, smooth, or may include ridges depending upon the media. For example, the belt may have a rough surface for better transportation of relatively smooth items, such as glossy photo paper. It will be evident to those skilled in the art that the belts may be manufactured using any other suitable material, such as rubber or other similar plastic compounds and may further vary in surface texture.

Joining the TE pushers 214, 216, and 218 and the LE pushers 210, and 212 to the belts involves various mechanical coupling methods, such as welding, bolting, groove & pulley, and chemical melting. In one implementation, integral and sequential formation of the belt teeth 222 with the belt involves molding the belt teeth 222 with the belt. In a further implementation, the belt teeth 222 can be urethane teeth.

As shown in FIG. 2, the TE pushers 214, 216, and 218 and the LE pushers 210, and 212 span the width of the first beltset 202 and the second beltset 204. It will be clear to those skilled in the art that there exist several conceivable pusher structures, including those described earlier, that may be employed for forming bins of varying sizes, while preventing media scatter.

In an exemplary embodiment, the apparatus 200 can operate in a high-speed mailing system for transporting envelopes, letters, inserts, boxes, or other similar items. The inlet station, which can be another conveyor belt, printer, storage area, mail-processing station, and so on, includes a laser scanner. A barcode is present on the transported items, holding information related to item size. The laser scanner reads the barcode to determine the item size. The transmission of the determined item size to the control module 220 results in the actuation of the first motor 206, the second motor 208, or both (the first motor 206 and the second motor 208), to adjust the bin size according to the determined item size. The bin size adjustment involves changing the relative distance between the TE pushers 214, 216, and 218 and the LE pushers 210, and 212 by actuating the motors (the first motor 206, the second motor 208, or both), responsible for the belt movement. The bin size adjustment takes place in the same manner as described earlier for the apparatus 200. Then, the items being transported are positioned within the bins and transported to the delivery station, which can be another conveyor belt, printer, another storage area, or any other mail-processing station (for example, envelope insertion station). Additionally, the apparatus 200 can be used in the transportation of various parts of machinery in an industrial conveyor application. It will be apparent to those skilled in the art that the apparatus 200 can be implemented in any industrial, mechanical, or electrical set-up for the transportation of different parts, items, boxes, or packages between an inlet station(s) and a delivery station(s).

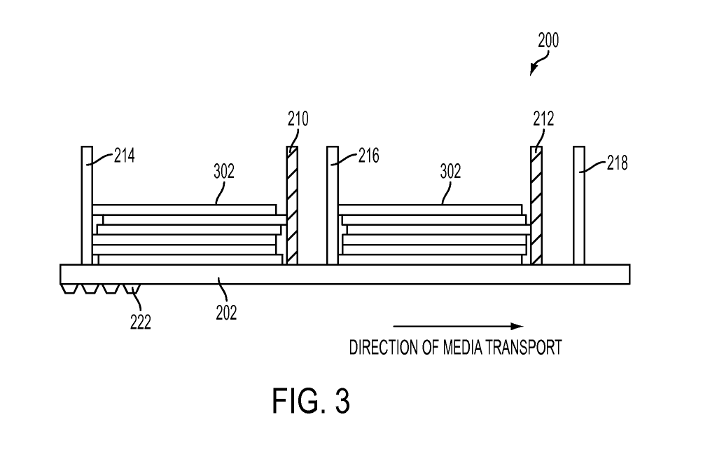

FIG. 3 illustrates an alternate view of stacked media on the apparatus 200. For instance, the apparatus 200 is implemented in a set-up where different sized media is transported between two stations. After transporting large media, the apparatus 200 needs to transfer relatively small sized media, which requires bin size adjustment to prevent media topple and scatter. Bin size adjustment occurs as described earlier in relation with the apparatus 200.

The apparatus 200 overcomes the disadvantages of conventional systems as the adjustment of the LE pushers 210, and 212 and the TE pushers 214, 216, and 218 according to the media size to attain optimum bin size prevents media scatter. In addition, the optimum bin size prevents curling, shingling and un-stacking of media 302 during transportation.

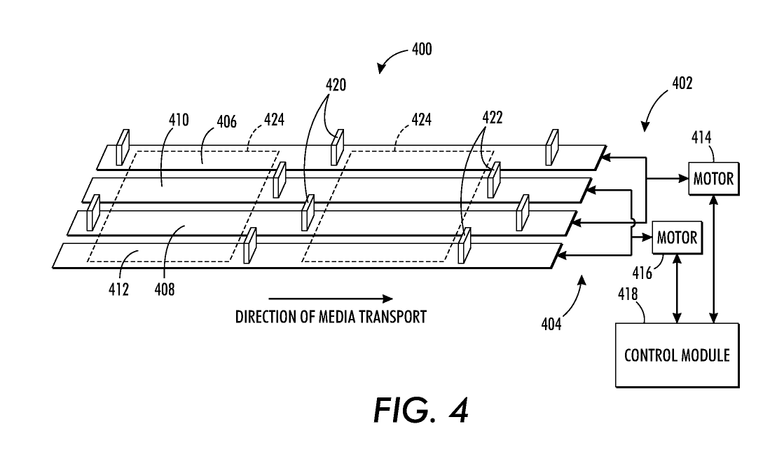

FIG. 4 exhibits an exemplary apparatus 400 for transporting variable-sized media having two belts in each beltset. The exemplary apparatus 400 includes two parallel beltsets—a first beltset 402 and a second beltset 404. The first beltset 402 includes a first belt 406 and a second belt 408. Similarly, the second beltset 404 includes a first belt 410 and a second belt 412. The belts of the first beltset 402 and the second beltset 404 are parallel to each other. A first motor 414, driving the first beltset 402, and a second motor 416, driving the second beltset 404, are coupled to a control module 418. Pusher-sets 420 and 422 form a bin 424 (shown in dotted lines), where the media for transportation (not shown for simplicity) is placed.

The pushers of the pusher-set 420 span a fraction of the width of the first belt 406 and the second belt 408 of the first beltset 402; alternatively, the pusher-set 420 may span the complete width of the beltsets. The same is true for the pushers of the pusher-set 422 on the first belt 410 and the second belt 412 of the second beltset 404. This pusher structure also forms a bin for carrying media satisfactorily, preventing media scatter. For instance, while transporting huge boxes, the small pushers will prevent box toppling. Similarly, when transporting a stack of sheets, relatively taller pushers will avoid non-alignment of a stack of sheets. As will be recognized by those of skill in the art, several conceivable pusher structures may be employed for forming bins of varying sizes, thus preventing media scatter. The operation of the exemplary apparatus 400 is as described for the apparatus 200 in FIG. 2.

A pusher may be attached to each belt in a beltset. In this case, more than two belts in a beltset results in multiple attachment points for a pusher, which strengthens the pusher structure and prevents the pusher from being deformed. The likelihood of pusher deflection reduces, as this pusher structure is far more robust as compared to a pusher attached to only one belt.

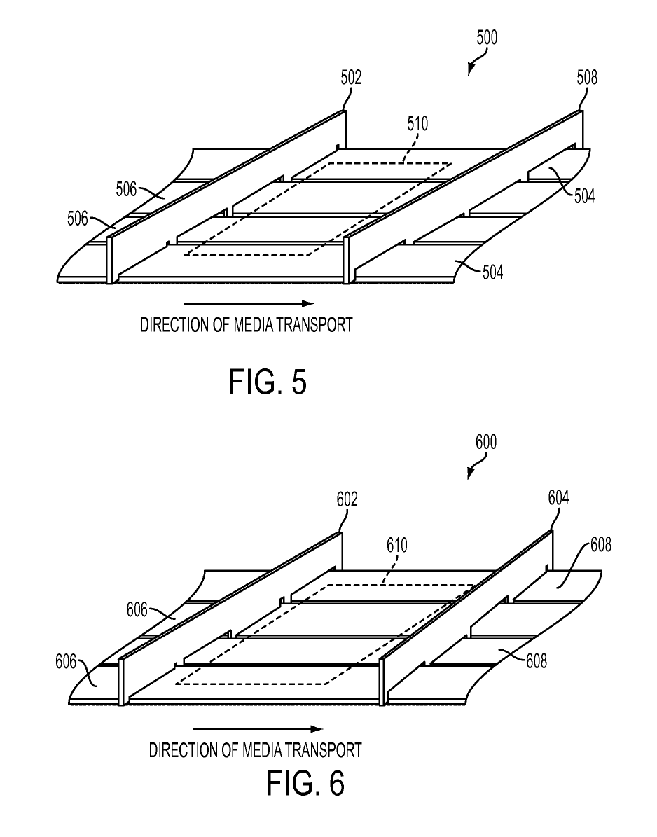

FIG. 5 illustrates an alternate embodiment of the exemplary apparatus 400. Here, an apparatus 500 presents an alternate pusher structure and includes two parallel beltsets having two parallel belts each. Pusher 502 spans both beltsets 504 and 506, although the pusher 502 is only attached to the belts of the beltset 504. Similarly, pusher 508 also spans both the beltsets 504 and 506, although the pusher 508 is attached only to the belts of the beltset 506. FIG. 5 shows the two belts of the beltset 504 separated by the beltset 506, which lies in the middle of the two belts of the beltset 504. Media, for transportation, is placed between the pushers 502 and 508 that form a bin 510 (shown in dotted lines). In this manner, the whole length of the media remains confined to the bin 510 and the media does not topple during transportation. The operation of the apparatus 500 is as described in relation with the apparatus 200 in FIG. 2.

FIG. 6 illustrates an alternate embodiment of the exemplary apparatus 400. Here, an apparatus 600 presents an alternative pusher structure where pushers 602 and 604 span two beltsets 606 and 608. The pusher 602 is attached to the belts of the beltset 606 while the pusher 604 is attached to the belts of the beltset 608. The belts of the beltset 606 intercalate with the belts of the beltset 608, as shown in FIG. 6. Media is placed between the pusher 602 and 604 that form a bin 610 (shown in dotted lines). The operation of the apparatus 600 is as described in relation with the apparatus 200 in FIG. 2.

It will be obvious to those skilled in the art that several conceivable pusher and beltset structures may be employed for forming bins of varying sizes, preventing media scatter, without departing from the scope and intended functions of the claimed invention.

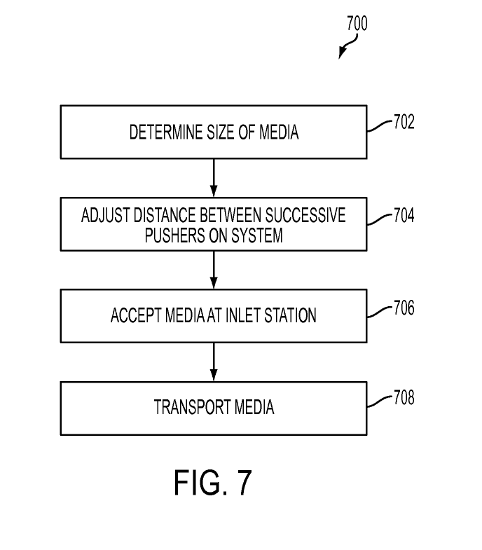

FIG. 7 illustrates a method 700 for transporting variable-sized media, allowing the adjustment of pushers based on the media size. The method 700 transports variable-sized media between an inlet station and a delivery station. The inlet station and delivery station can be a conveyor belt, printer, storage area, collection area, or processing unit or the inlet and delivery station can be part of a material handling system. The method 700 may be performed in conjunction with the apparatus 200 described in relation with FIG. 2. Two or more adjacent, parallel beltsets situated between the inlet station and the delivery station, have one or more belts each. Each beltset, coupled to an independently controlled motor, drives the beltset. Multiple TE and LE pushers project vertically from one or more of the belts. The distance between the two successive TE and LE pushers is greater than the size of the largest media item that can be transported. The adjustment of the distance between the TE and LE pushers helps in attaining an optimum bin size. The bin size is adjusted in the same manner as described earlier for the apparatus 200.

A sensor device, as explained in relation with the apparatus 200 in FIG. 2, determines the media size at step 702. Alternatively, an operator can provide the media size manually. The media size is transmitted to the control module 220, which, based on the determined media size, adjusts the bin size by actuating one or both of the first motor 206 and the second motor 208, at step 704. After the bin size adjustment, the present embodiment accepts media at an inlet station at step 706 and the first beltset 202 and the second beltset 204 transport the media to the delivery station at step 708. As will be appreciated by those of skill in the art, various modifications to the pusher structure can be made without departing from its function of preventing media scatter.

The disclosed method 700 eliminates the need for addition of pushers, flight bars, manually or mechanically, to the belt for bin size adjustment. Moreover, the method 700 allows bin size variation without operator intervention, reducing the operating time.

The method 700 can be associated with any suitable material handling application, allowing variable bin size and enabling transport of different sized media between an inlet station and a delivery station, and thus ensuring higher productivity for the material handling application. Those of skill in the art will comprehend that the disclosed systems and methods can also be used to transport various parts of machinery in an industrial conveyor application or any other similar set-up.

While this specification contains many specific implementation details, these should not be construed as limitations on the scope of any invention or of what may be claimed, but rather as descriptions of features, that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Similarly, while operations are depicted in the drawings in a particular order, this should not be understood as requiring that such operations be performed in the particular order shown or in sequential order, or that all illustrated operations be performed, to achieve desirable results. Various presently unforeseen or unanticipated alternatives, modifications, variations, or improvements therein may be subsequently made by those skilled in the art which are also intended to be encompassed by the following claims.

What is claimed is:

1) A system for transporting variable-sized media, comprising:
a plurality of adjacent parallel beltsets situated between an inlet station and a delivery station, each beltset including:
one or more parallel belts;
a motor operatively connected to drive the beltset;
a plurality of pushers attached to one or more belts of the beltset, the pushers being spaced apart at least a distance greater than the largest media to be transported;
wherein the pushers of one beltset are situated between successive pushers of the adjacent beltset; and
a control module, coupled to each motor for adjusting the distance between pushers of adjacent beltsets, based on the size of the media to be transported.

2) The system of claim 1, wherein a pusher includes one or more protrusions from the lower part of the pusher.

3) The system of claim 1 further comprising a sensor device configured to:
sense the size of the media to be transported; and
transmit the sensed size of the media to be transported to the control module.

4) The system of claim 1, wherein the control module includes a user interface configured to allow input of user instructions.

5) The system of claim 1, wherein pushers are attached to the belt by mechanical coupling.

6) The system of claim 1, wherein pushers are attached to the belt by welding.

7) The system of claim 1, wherein pushers span the width of one or more beltsets.

8) The system of claim 1, wherein pushers span a fraction of the width of one or more beltsets.

9) A method for transporting variable-sized media, comprising:
providing a plurality of adjacent parallel beltsets situated between an inlet station and a delivery station, each beltset including
one or more parallel belts;
a motor operatively connected to drive the beltset;
a plurality of pushers attached to one or more belts of the beltset, the pushers being spaced apart at least a distance greater than the largest media to be transported;
wherein the pushers of one beltset are situated between successive pushers of the adjacent beltset;
determining the size of the media to be transported;
adjusting the distance between two consecutive pushers on the system based on the size of the media to be transported, using a control module that is coupled to all the motors; and
transporting the media from the inlet station to the delivery station.

10) The method of claim 9, further comprising the steps of:
sensing the size of the media to be transported; and
transmitting the sensed size of the media to be transported to the control module.
